(19) United States
(12) Patent Application Publication
(10) Pub. No.: US 2012/0242858 A1
(43) Pub. Date: Sep. 27, 2012

(54) DEVICE AND METHOD FOR COMPENSATING FOR RELIEF IN HYPERSPECTRAL IMAGES

(76) Inventors: Sylvain Prigent, Biot (FR); Xavier Descombes, Antibes (FR); Josiane Zerubia, Cannes La Bocca (FR); Didier Zugaj, Mougins-le-haut (FR); Laurent Petit, Peymeinade (FR)

(21) Appl. No.: 13/504,865

(22) PCT Filed: Oct. 28, 2010
(86) PCT No.: PCT/EP2010/066342

§ 371 Date: Jun. 14, 2012

(30) Foreign Application Priority Data
Oct. 29, 2009 (FR) 0957626

(51) Int. Cl. H04N 5/225

(52) U.S. Cl. 348/222.1; 348/E05.024

(57) ABSTRACT

The invention relates to a device for adjusting the raised pattern of at least one hyper-spectral image including at least one sensor capable of producing at least one hyper-spectral image in at least two wavelengths, a computing means capable of classifying the pixels of the hyper-spectral image derived from the sensor on the basis of a two-state classification relationship, and a display means capable of displaying at least one image on the basis of the classified pixels from the computing means. The computing means includes a means for adjusting the raised pattern on the basis of at least one reference image.

### BACKGROUND OF THE INVENTION

1. Field of the Invention

The present invention relates to the analysis of images and more particularly the statistical classification of the pixels of an image. It relates more particularly to the statistical classification of the pixels of an image with a view to the detection of skin lesions, such as acne, melasma and rosacea.

2. Description of the Relevant Art

Chemical materials and elements react to a greater or lesser extent when they are exposed to radiation of a given wavelength. By scanning the range of radiation, it is possible to differentiate materials contributing to the composition of an object by way of their difference in interaction. This principle may be generalized to a landscape, or to a part of an object.

The whole of a set of images coming from the photograph of the same scene at different wavelengths is referred to as a hyperspectral image or hyperspectral cube.

A hyperspectral image is composed of a set of images each pixel of which is characteristic of the intensity of the interaction of the scene observed with the radiation. Knowing the interaction profiles of the materials with various kinds of radiation, it is possible to determine the materials present. The term material must be understood in the wider sense, being just as applicable to solid, liquid and gaseous substances, and also just as applicable to the pure chemical elements as to complex assemblages of molecules or macromolecules.

The acquisition of hyperspectral images can be carried out according to several methods.

The method for acquisition of hyperspectral images referred to as a spectral scan consists in using a sensor of the CCD type to form spatial images, and in applying different filters in front of the sensor so as to select one wavelength for each image. Various filter technologies allow the requirements of such imagers to be met. Liquid crystal filters may for example be mentioned that isolate one wavelength by electrical stimulation of crystals, or acousto-optical filters that select a wavelength by deforming a prism by means of an electrical potential difference (piezo-electric effect). These two filters have the advantage of not having moving parts which are often a source of fragility in optics.

The method for acquisition of hyperspectral images referred to as spatial scan aims to acquire, or “image”, simultaneously all the wavelengths of the spectrum on a sensor of the CCD type. In order to obtain the decomposition of the spectrum, a prism is placed in front of the sensor. Subsequently, in order to form the complete hyperspectral cube, a row by row spatial scanning is performed.

The method for acquisition of hyperspectral images referred to as temporal scan consists in performing an interference measurement, then in recomposing the spectrum by applying a fast Fourrier transform, or FFT, to the interference measurement. The interference is produced by means of a system of the Michelson type, which causes radiation to interfere with its time-shifted self.

The final method for acquisition of hyperspectral images aims to combine the spectral scan and the spatial scan. Thus, the CCD sensor is partitioned in the form of blocks. Each block of the CCD sensor processes the same region of space but with different wavelengths. Then, a spectral and spatial scanning allow a complete hyperspectral image to be composed.

Several methods exist for analyzing and classifying hyperspectral images thus obtained, in particular for the detection of lesions or diseases in human tissue.

The document WO 99 44010 describes a method and a device for hyperspectral imaging for the characterization of a tissue from the skin. In this document, the purpose is to detect a melanoma. This method is a method for characterization of the state of a region of interest of the skin, in which the absorption and the scattering of the light in various frequency ranges are dependant on the state of the skin. This method comprises the generation of a digital image of the skin including the region of interest in at least three spectral bands. This method implements a classification and a characterization of lesions. It comprises a segmentation step used to carry out a discrimination between the lesions and the normal tissue depending on the different absorption of the lesions as a function of wavelength, and an identification of the lesions by analysis of parameters such as the texture, the symmetry, or the contour. Lastly, the classification per se is effected based on a classification parameter L.

The document U.S. Pat. No. 5,782,770 describes an apparatus for diagnosing cancerous tissue and a diagnostic method comprising the generation of a hyperspectral image of a sample of tissue and the comparison of this hyperspectral image with a reference image in order to diagnose a cancer without introducing specific agents facilitating the interaction with light sources.

The document WO 2008 103918 describes the use of imaging spectrometry for the detection of a cancer of the skin. It includes a hyperspectral imaging system allowing high-resolution images to be rapidly acquired whilst avoiding the correction adjustment of images, the problems of image distortion or the movement of the mechanical components. It comprises a source of multi-spectral light which illuminates the region of the skin to be diagnosed, an image sensor, an optical system receiving the light from the region of skin and generating on an image sensor a mapping of the light bounding the various regions, and a dispersion prism positioned between the image sensor and the optical system in order to project the spectrum of the separate regions onto the image sensor. An image processor receives the spectrum and analyzes it so as to identify cancerous anomalies.

The document WO 02/057426 describes an apparatus for generation of a two-dimensional histological map based on a cube of three-dimensional hyperspectral data representing the scanned image of the cervix of the uterus of a patient. It comprises a processor with an input normalizing the fluorescent spectral signals collected from the cube of hyperspectral data and extracting the pixels from the spectral signals indicating the classification of the cervical tissues. It also comprises a classification device which makes a category of tissue correspond to each pixel and an image processor linked with the classification device which generates a two-dimensional image of the cervix of the uterus from the pixels including coded regions using a color code representing the classifications of the tissues of the cervix of the uterus.

The document US 2006/0247514 describes a medical instrument and a method for detection and for evaluation of a cancer by means of hyperspectral images. The medical instrument notably comprises a first optical stage illuminating the tissue, a spectral separator, one or more polarizers, an image detector, a diagnostic processor and a filter control interface. The method can be used without contact, by means of a camera, and allows information to be obtained in real time. It notably comprises a pre-processing of the hyperspectral information, the construction of a visual image, the definition of a region of interest of the tissue, the conversion of the intensities of the hyperspectral images into units of optical density, and the decomposition of a spectrum for each pixel into several independent components.

The document US 2003/0030801 describes a method allowing one or more images to be obtained from an unknown sample by illuminating the target sample with a reference spectral distribution weighted for each image. The method analyzes the resulting image or images and identifies the target characteristics. The weighted spectral function thus generated can be obtained from a sample of reference images and can for example be determined by an analysis of its main component, by projection tracking or by analysis of independent components ACI. The method is usable for the analysis of samples of biological tissues.

These documents process the hyperspectral images either as collections of images to be processed individually, or by taking a cross-section of the hyperspectral cube so as to obtain a spectrum for each pixel, the spectrum then being compared with a reference database. Those skilled in the art clearly realize the deficiencies of these methods, both as regards the methodology and with respect to the speed of processing. Furthermore, the methods may be mentioned based on the system of representation CIEL*a*b, and spectral analysis methods, notably the methods based on the measurement of reflectance and those based on the analysis of the absorption spectrum. However, these methods are not adapted to hyperspectral images and to the quantity of data characterizing them.

It has been observed that the classification of hyperspectral images is flawed with errors associated with non-detections within regions of the image comprising relief.

There therefore exists a need for a compensation for relief in hyperspectral images classified by projection tracking and support vector machine or by independent component analysis.

### SUMMARY OF THE INVENTION

One subject of the invention is a device for compensating for the relief in hyperspectral images classified by projection tracking and a support vector machine.

Another subject of the invention is a method for compensating for the relief in hyperspectral images classified by projection tracking and a support vector machine.

Another subject of the invention is a device for compensating for the relief in hyperspectral images classified by independent component analysis.

Another subject of the invention is a method for compensating for the relief in hyperspectral images classified by independent component analysis.

Another subject of the invention is the application of the device for compensating for the relief in classified hyperspectral images to the detection of skin lesions.

The device for compensating for the relief in at least one hyperspectral image comprises at least one sensor capable of producing at least one hyperspectral image in at least two wavelengths, a calculation means capable of classifying the pixels of the hyperspectral image coming from the sensor according to a classification relationship with two states, and a display means capable of displaying at least one image function of the classified pixels coming from the calculation means.

The calculation means comprises a means for compensating for the relief as a function of at least one reference image.

The means for compensating for the relief can be capable of linearly combining a reference image with a hyperspectral image.

The means for compensating for the relief can be capable of linearly combining a reference image with a hyperspectral image by linearly combining the intensity of each of the pixels of each wavelength of the hyperspectral image with the intensity of the corresponding pixel of the reference image.

The reference image can be an image of a given wavelength included in the hyperspectral image generated by the sensor.

The reference image can be an image included in the reduced hyperspectral image generated by the calculation means.

The calculation means can comprise at least one calculation means for a projection tracking, and at least one means for producing a support vector machine.

The calculation means can comprise at least one means of independent component analysis.

According to another aspect of the invention, the compensation device is applied to the detection of skin lesions on a human being, the reference image being acquired by a sensor in a wavelength situated in the infrared domain.

According to another aspect of the invention, the compensation device is applied to the detection of skin lesions on a human being, the reference image being acquired by a sensor in a wavelength situated in the near-infrared domain.

According to another aspect of the invention, the compensation device is applied to the detection of skin lesions on a human being, the reference image corresponding to a composite image coming from the projection tracking corresponding to the projection onto an image vector carried out in the infrared and the near-infrared.

According to another aspect of the invention, the method for compensating for the relief in at least one hyperspectral image coming from at least one sensor capable of producing at least one hyperspectral image in at least two wavelengths, comprises at least one calculation step capable of classifying the pixels of the hyperspectral image coming from the sensor according to a classification relationship with two states, and a display step capable of displaying at least one image function of the classified pixels coming from the calculation step. The calculation step comprises a step for compensating for the relief as a function of at least one reference image.

During the step for compensating for the relief, at least one hyperspectral image can be normalized as a function of a reference image.

A hyperspectral image can be normalized as a function of a reference image, by dividing the intensity of each of the pixels composing the hyperspectral image by the intensity of the corresponding pixel of the reference image.

During the step for compensating for the relief, a reference image can be linearly combined with a hyperspectral image.

A reference image can be linearly combined with a hyperspectral image by linearly combining the intensity of each of the pixels of each wavelength of the hyperspectral image with the intensity of the corresponding pixel of the reference image.

The reference image can be an image of a given wavelength included in the hyperspectral image generated by the sensor.

The reference image can be an image included in the reduced hyperspectral image coming from the step for calculation of a projection tracking.

The calculation step can comprise at least one step for calculation of a projection tracking, and at least one step for producing a support vector machine.

The calculation step can comprise at least one step for independent component analysis.

### BRIEF DESCRIPTION OF THE DRAWINGS

Other aims, features and advantages will become apparent upon reading the following description presented solely by way of non-limiting example and with reference to the appended figures, in which:

FIG. 1 illustrates the main components of a device for compensating for relief in hyperspectral images according to a variant of one embodiment;

FIG. 2 illustrates the main components of a device for compensating for relief in hyperspectral images according to another variant of one embodiment;

FIG. 3 illustrates the main components of a device for compensating for relief in hyperspectral images according to another embodiment;

FIG. 4 illustrates the main steps of a method for compensating for relief in hyperspectral images according to a variant of one embodiment;

FIG. 5 illustrates the main steps of a method for compensating for relief in hyperspectral images according to another variant of one embodiment; and

FIG. 6 illustrates the main steps of a method for compensating for relief in hyperspectral images according to another embodiment.

### DETAILED DESCRIPTION OF THE PREFERRED EMBODIMENTS

As previously described, several ways exist for obtaining a hyperspectral image. However, whatever the method of acquisition, it is not possible to perform a classification directly on the hyperspectral image as acquired.

It is here recalled that a hyperspectral cube is a set of images each formed at a given wavelength. Each image is two-dimensional, the images being stacked in a third direction according to the variation in their corresponding wavelength. Owing to the three-dimensional structure obtained, the whole structure is referred to as a hyperspectral cube. The term ‘hyperspectral image’ may also be employed to denote the same entity.

A hyperspectral cube contains a significant quantity of data. However, in such cubes, large empty spaces in terms of information and sub-spaces containing a lot of information are found. The projection of the data into a space of lower dimension therefore allows the useful information to be assembled into a reduced space while only generating a very small loss of information. This reduction is then important for the classification.

It is recalled that the aim of the classification is to determine, from amongst the set of pixels composing the hyperspectral image, those which respond favorably or unfavorably to a classification relationship with two states. It is thus possible to determine the parts of a scene having a characteristic or a substance. The classification can be carried out in at least two different ways, by projection tracking and support vector machine or by decomposition into independent components.

When the classification is carried out by projection tracking and support vector machine, it essentially comprises two steps. A first step corresponds to a step for projection tracking during which the hyperspectral cube will be reduced by projection onto projection vectors in order to obtain a reduced hyperspectral image. A second step corresponds to a support vector machine step during which the pixels of the reduced hyperspectral image will be classified according to a classification relationship with two states.

When the classification is carried out by decomposition into independent components (ACT), alternatively referred to as separation of sources, a method is applied that aims to decompose a hyperspectral image into, at the most, as many components as there are images forming the hyperspectral image, in such a manner that these components are statistically independent of one another.

Mathematically, linear source separation takes the following form:

Xᵢⱼ=A.Sᵢⱼ+Bᵢⱼ (Eq. 1)

In this model, the analysis is performed on each pixel vector individually because only the spectral information matters. Spectral information is understood to mean the variation in intensity as a function of wavelength for a given pixel (in other words when the coordinates (x;y) of the pixel are fixed). Carrying out an independent component analysis of a hyperspectral image therefore amounts to determining the mixing matrix A, after having removed the noise from the image.

The matrix A contains, in each column k, the combination of the spectral bands which allows the pure k-th component to be recovered.

The vector Sᵢⱼ, which contains the proportions of each of the pure components forming the vector Xᵢⱼ, must comply with the following conditions:

$$\begin{matrix}∀ k ∈ [ 0 , N ] , {S}_{ij} ( k ) \geq 0 \\ and & ( Eq . 2 ) \\ {\sum }_{k = 1}^{N} {S}_{ij} ( k ) = 1 & ( Eq . 3 )\end{matrix}$$

Indeed, a component having a negative value on a vector makes no sense (the intensity measured at a given wavelength is at least zero, a negative intensity having no physical meaning). Similarly, a component the sum of the proportions of which is different from unity would have no sense, since a part would be missing.

The linear source separation model defined hereinabove exhibits two indeterminations. This is because the permutation of the columns of A modifies the order of the sources. The definition of the model is therefore indeterminate in one permutation. In addition, if the columns of A are multiplied by non-zero constants, this leads to a second indetermination of the model, this time relating to the amplitude of the sources. This second indetermination, for the particular case where the constant multiplier is equal to −1, leads to the appearance of a negative source.

The crucial element with regard to the success of a decomposition into independent components resides in the estimation of the mixing matrix A. In order to perform this estimation of A, two families of algorithms can be differentiated.

The first consists in estimating A iteratively, by methods allied to the gradient descent procedure, by optimizing a criterion of independence between the components. This type of method is therefore very close to those used previously for the projection tracking.

The second family of algorithms allows A to be estimated by defining the independence between the components by means of the matrices of the cumulants. Thus, A is constructed by diagonalization of the matrices of the cumulants. In a publication (“High order contrasts for independent component Analysis”, Neural Computation, Vol. 11, No. 1, pp 157-192, January 1999, J. F. Cardoso et al.), Cardoso shows that the fact of choosing the cumulants of the second and fourth order allows a method to be developed mathematically equivalent to an independent component analysis by minimization of the Kullback-Leibler index.

The methods for reduction of hyperspectral data by independent component analysis allow a reduced hyperspectral image cube to be obtained. However, as for the method of projection tracking and support vector machine, the presence of relief or of shadows can lead to a detection problem.

Thus, whatever the method for reduction of the data of a hyperspectral cube, it is important to carry out a pre-processing on the hyperspectral cube in such a manner as to best compensate for these effects of relief, so as to favor the classification of the pixels situated in the regions of relief or influenced by the regions of relief.

When the reduction by projection tracking and support vector machine is considered, two methods of compensation can be applied. A first method is a method for compensation by normalization.

When the projection tracking algorithm followed by a support vector machine (SVM) is directly applied to a data cube, non-detections occur within the regions where there is relief in the image. In order to be able to detect the characteristics of these regions, a pre-processing on the image cube must therefore be carried out in such a manner as to best compensate for these effects of relief.

In order to compensate for the effects of relief, an image only comprising information relating to the relief, and devoid of information able to be classified by the SVM, is used. It is for example possible to move to a region of the spectrum in which the electromagnetic wave will not react with the components of the scene being analyzed. Each of the images of the cube is then divided pixel by pixel by the reference image. This results in a good compensation for the effects of shadows on the edges of the images.

A second method is a method for compensation by subtraction.

Still based on a reference image only comprising information relating to the relief, a method is provided for normalization by subtraction of the relief from the whole set of images of the cube. In order to implement the model of the relief, an image C is introduced which measures the difference in levels between the maximum of the reference image and all of the pixels of the reference image:

C(i,j)=Max(IR)−IR(i,j) (Eq. 1)

IR representing a near-infrared image, and i,j the position indices of each pixel in the image.

Subsequently, each of the images of the cube can be compensated by this image C:

$${I}_{{λ}_{c}} = {I}_{λ} + z \cdot C \\ with z = \frac{max ( λ ) - {min}_{\neq 0} ( λ )}{max ( IR ) - {min}_{\neq 0} ( IR )} \qquad ( Eq . 2 )$$

and with I_{λ} representing an image of the cube, and I_{λc} this same image after compensation. A factor z is introduced so as to account for the differences in scales between the images. The factor z is the ratio between the difference between the maximum intensity and the minimum intensity of an image of the hyperspectral cube denoted λ and the difference between the maximum intensity and the minimum intensity of the reference image denoted IR.

The method for compensation by subtraction, also referred to as method for compensation by linear combination by reason of the equation Eq. 2, allows the number of false detections to be even further reduced with respect to the method for compensation by normalization.

As a variant, it is also possible to apply this compensation to the cube reduced by projection tracking rather than the initial cube. Thus, a compensation is not carried out by a single reference image but by a linear combination of several reference images situated in a neighboring range of frequencies and exhibiting the complete faculty for only reacting to the relief in the observed scene.

When the reduction by independent component analysis is employed, it is not possible to compensate for the relief by means of a pre-processing. If a compensation by pre-processing is carried out, each of the images is just translated or multiplied by the same image (except for the factor z in the case of the compensation by subtraction), which generates a cube equivalent to the first one from the point of view of the ACI.

In order to decrease the effects of relief, the compensation is therefore applied in post-processing mode to the selected source.

If the source is compensated by normalization by a given band, then, as for projection tracking and SVM, the number of false detections due to the shadows decreases, but not the false detections due to the relief. Finally, the compensation by subtraction allows both the false detections due to the relief and due to the shadows to be decreased.

The device for compensating for the relief comprises at least one sensor 1 capable of producing at least one hyperspectral image in at least two wavelengths, a calculation means 2 capable of processing the data received from a sensor. A display means 3 is capable of displaying at least one classified image coming from the calculation means 2.

According to the method for reduction of the hyperspectral data, various calculation means 2 may be considered.

In one embodiment, the calculation means 2 comprises at least one means 4 for calculating a projection tracking, and at least one means 5 for generating a support vector machine.

In another embodiment, the calculation means 2 comprises a means 12 for calculation by independent component analysis.

The calculation means 2 furthermore comprises a means 6 for compensating for the relief as a function of at least one reference image.

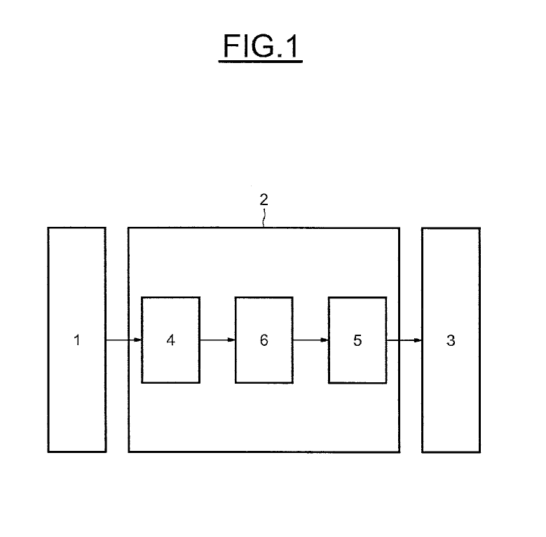

In one variant of the first embodiment illustrated in FIG. 1, the means 6 for compensating for the relief is situated between the means 4 for calculating a projection tracking and the means 5 for generating a support vector machine.

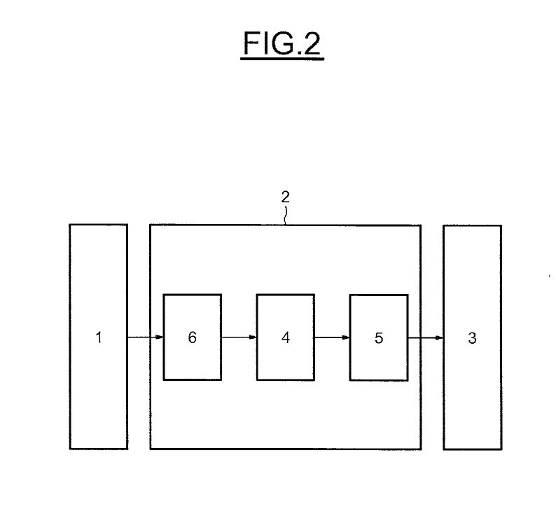

In another variant of the first embodiment illustrated in FIG. 2, the means 6 for compensating for the relief is situated between the sensor 1 and the means 4 for calculating a projection tracking.

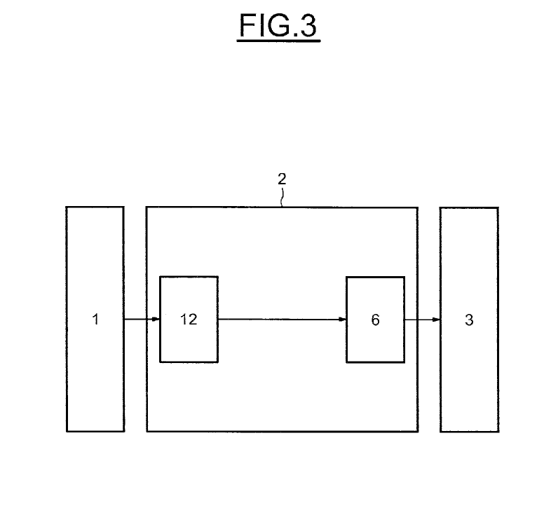

In the second embodiment illustrated in FIG. 3, the means 6 for compensating for the relief is situated between the means 12 for calculating by independent component analysis and the display means 3.

The method for compensating for the relief in a hyperspectral image, at at least two wavelengths, comprises a calculation step capable of processing the data received from an acquisition step 7 and a display step 11 capable of displaying at least one classified image coming from the calculation step.

According to the method for reduction of the hyperspectral data, various calculation steps may be considered.

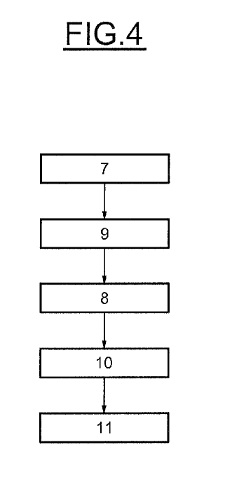

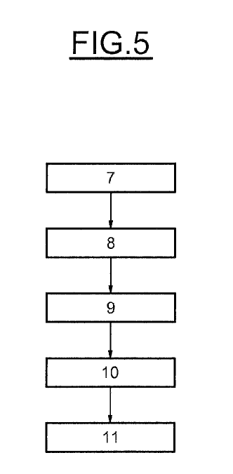

In one embodiment illustrated in FIGS. 4 and 5, the calculation step comprises at least one step 8 for calculating a projection tracking, followed by at least one step 10 for generating a support vector machine.

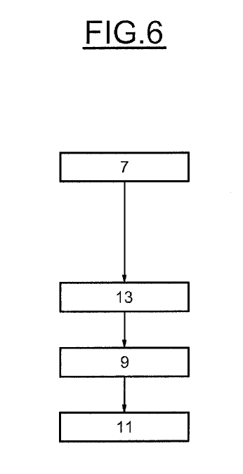

In another embodiment illustrated in FIG. 6, the calculation step comprises a step 13 for calculation by independent component analysis.

The calculation step furthermore comprises a step 9 for compensating for the relief as a function of at least one reference image.

In one variant of the first embodiment illustrated in FIG. 4, the step 9 for compensating for the relief is situated between the step 7 for acquisition of the hyperspectral image by at least one sensor 1 and the step 8 for calculation of a projection tracking.

In another variant of the first embodiment illustrated in FIG. 5, the step 9 for compensating for the relief is situated between the step 8 for calculating a projection tracking and the step 10 for generation of a support vector machine.

In the second embodiment illustrated in FIG. 6, the step 9 for compensating for the relief is situated between the step 13 for calculation by independent component analysis and the display step 11.

Furthermore, the reference image allowing the compensation for the relief can be a single image representing the relief to be compensated, or an image at a given wavelength also representative of the relief to be compensated, or a linear combination of several reference images.

In the framework of a dermatological application, the goal is to determine the presence of skin lesions. The skin reacts very little to radiation in the near-infrared. The images taken at these wavelengths virtually only then comprise the relief due to the morphology of the patient (nose, mouth, etc.), and the image edge shadows. The reference images are therefore taken either in the infrared range, or in the near-infrared range, or in a linear combination of the two in the case where a projection vector is chosen situated in the infrared and determined by the projection tracking step for compensating the reduced hyperspectral image, this also coming from the projection tracking.

1. A device for compensating for the relief in at least one hyperspectral image comprising:
at least one sensor capable of producing at least one hyperspectral image in at least two wavelengths,
a calculation means capable of classifying the pixels of the hyperspectral image coming from the sensor according to a classification relationship with two states,
a display means capable of displaying at least one image function of the classified pixels coming from the calculation means,
wherein the calculation means comprises a means for compensating for the relief as a function of at least one reference image.

2. The compensation device as claimed in claim 1, in which the means for compensating for the relief is capable of linearly combining a reference image with a hyperspectral image.

3. The compensation device as claimed in claim 2, in which the means for compensating for the relief is capable of linearly combining a reference image with a hyperspectral image by linearly combining the intensity of each of the pixels for each wavelength of the hyperspectral image with the intensity of the corresponding pixel of the reference image.

4. The compensation device as claimed in claim 1, in which the reference image is an image of a given wavelength included in the hyperspectral image generated by the sensor.

5. The compensation device as claimed in claim 1, in which the reference image is an image included in the reduced hyperspectral image generated by the calculation means.

6. The compensation device as claimed in claim 1, in which the calculation means comprises at least one calculation means for a projection tracking, and at least one means for producing a support vector machine.

7. The compensation device as claimed in claim 1, in which the calculation means comprises at least one means of independent component analysis.

8. A method of detecting skin lesions on a human being, comprising acquiring a reference image using the device of claim 1, the reference image being acquired by a sensor in a wavelength situated in the infrared domain.

9. The method of claim 8, wherein the reference image is acquired by a sensor in a wavelength situated in the near-infrared domain.

10. The method of claim 1, wherein the reference image corresponds to a composite image coming from the projection tracking corresponding to the projection onto an image vector carried out in the infrared and the near-infrared.

11. A method for compensating for the relief in at least one hyperspectral image coming from at least one sensor capable of producing at least one hyperspectral image in at least two wavelengths, comprising at least one calculation step capable of classifying the pixels of the hyperspectral image coming from the sensor according to a classification relationship with two states, and a display step capable of displaying at least one image function of the classified pixels coming from the calculation step, wherein the calculation step comprises a step for compensating for the relief as a function of at least one reference image.

12. The compensation method as claimed in claim 11, in which, during the step for compensating for the relief, a reference image is linearly combined with a hyperspectral image.

13. The compensation method as claimed in claim 12, in which a reference image is linearly combined with a hyperspectral image by linearly combining the intensity of each of the pixels of each wavelength of the hyperspectral image with the intensity of the corresponding pixel of the reference image.

14. The compensation method as claimed in claim 11, in which the reference image is an image of a given wavelength included in the hyperspectral image generated by the sensor.

15. The compensation method as claimed in claim 11, in which the reference image is an image included in the reduced hyperspectral image coming from the step for calculation of a projection tracking.

16. The compensation method as claimed in claim 11, in which the calculation step comprises at least one step for calculation of a projection tracking, and at least one step for producing a support vector machine.

17. The compensation method as claimed in claim 11, in which the calculation step comprises at least one step for independent component analysis.
